(19) United States
(12) Patent Application Publication
(10) Pub. No.: US 2007/0184785 A1
(43) Pub. Date: Aug. 9, 2007

(54) RADIO COMMUNICATOR

(75) Inventors: Hiroshi Yoshida, Kanagawa-ken (JP); Ichiro Seto, Tokyo (JP); Shuichi Sekine, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/672,874

(22) Filed: Feb. 8, 2007

(30) Foreign Application Priority Data
Feb. 8, 2006 (JP) P2006-30661

(51) Int. Cl. H04B 1/38

(52) U.S. Cl. 455/73

(57) ABSTRACT

A radio communicator including a first antenna configured to emit radio signal as a first linear polarized wave; a second antenna arranged perpendicular to the first antenna and configured to emit radio signal as a second linear polarized wave; a receiver configured to monitor a radio wave condition in the air; a transmitter configured to convert transmission data to a first radio signal and a second radio signal with a phase orthogonal to the phase of the first radio signal, and to transmit the first radio signal and the second radio signal through the first antenna and the second antenna; and a controller configured to make judgment of the radio wave condition monitored by the receiver, to direct the transmitter to transmit the first radio signal through the first antenna and to transmit the second radio signal through the second antenna when the result of the judgment is first condition, and to direct the transmitter to transmit an addition signal which is an addition of the first radio signal and the second radio signal through the first antenna when the result of the judgment is the second condition.

### CROSS REFERENCE TO RELATED APPLICATIONS

This application is based upon and claims a benefit of priority under 35 U.S.C. § 119 from prior Japanese Patent Application P2006-30661 filed on Feb. 8, 2006, the entire contents of which are incorporated by reference herein.

### BACKGROUND OF THE INVENTION

1. Field of the Invention

Exemplary embodiments of the invention relate to a radio communicator that has a plurality of polarization functions.

2. Discussion of the Background

Recently, radio communications use high frequency waves, so called “Millimeter-waves” including the 60 GHz band, which can be transmitted and received with small antennas.

Jeon et al. suggest to develop such small antenna and circuits on an IC (see, Jeon et al., “Millimeter wave direct quadrature converter integrated with antenna for broad-band wireless communications, “Microwave Symposium Digest, 2002 IEEE MTT-S International Volume 2, 2-7 Jun. 2002 Page(s): 1277-1280). The text describes a radio communicator which modulates a baseband signal to an in-phase component and a quadrature component in QPSK (Quadrature Phase Shift Keying) by a quadrature modulator, converts the in-phase component and the quadrature component to a radio frequency signal by a frequency converter, and radiates the radio frequency signal from an antenna as linear polarized wave.

However, there is a problem that linear polarized wave is easily delayed by environmental delay factors such as a wall. Although the absolute amount of such delay is very small, nevertheless it is large for a transmission data rate used with the millimeter-wave.

On the other hand, a circular polarized wave hardly experiences interference by such environmental delay factors. JP-A-2004-320583 discloses a combined use of the linear polarized wave and the circular polarized wave in a radio communicator, where the linear polarized wave is converted to circular polarized wave when the radio communicator is in an environment where wave reflection is likely to happen. But the structure for such a conversion is too large to implement on an IC for a millimeter-wave radio communicator.

### SUMMARY OF THE INVENTION

According to one aspect of the present invention there is provided a radio communicator, including a first antenna configured to emit a radio signal as a first linear polarized wave; a second antenna arranged perpendicular to the first antenna and configured to emit a radio signal as a second linear polarized wave; a receiver configured to monitor a radio wave condition in the air; a transmitter configured to convert transmission data to a first radio signal and to a second radio signal with a phase orthogonal to the phase of the first radio signal, and to transmit the first radio signal and the second radio signal through the first antenna and the second antenna; and a controller configured to make a judgment of the radio wave condition monitored by the receiver, to direct the transmitter to transmit the first radio signal through the first antenna and to transmit the second radio signal through the second antenna when the result of the judgment is a first condition, and to direct the transmitter to transmit an addition signal which is an addition of the first radio signal and the second radio signal through the first antenna when the result of the judgment is a second condition.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram illustrating an example of a radio communicator according to a first exemplary embodiment;

FIG. 2 is a block diagram illustrating a diagram of an example of a transmitter of a radio communicator according to a first exemplary embodiment;

FIG. 3 is a functional block diagram illustrating a first partial diagram of a transmitter of a radio communicator according to a first exemplary embodiment;

FIG. 4 is a functional block diagram illustrating a second partial diagram of a transmitter of a radio communicator according to a first exemplary embodiment;

FIG. 5 is a functional block diagram illustrating a third partial diagram of a transmitter of a radio communicator according to a first exemplary embodiment;

FIG. 6 is a block diagram illustrating a diagram of an example of a transmitter of a radio communicator according to a second exemplary embodiment;

FIG. 7 is a functional block diagram illustrating operation of a mixer of a transmitter of a radio communicator according to a second exemplary embodiment;

FIG. 8 is a block diagram illustrating a partial diagram of a transmitter of a radio communicator according to a second exemplary embodiment;

FIG. 9 is a flow chart illustrating a first exemplary operation of a controller of a radio communicator according to a third exemplary embodiment;

FIG. 10 is a flow chart illustrating a second exemplary operation of a controller of a radio communicator according to a third exemplary embodiment;

FIG. 11 is a flow chart illustrating a third exemplary operation of a controller of a radio communicator according to a third exemplary embodiment; and

FIG. 12 is a flow chart illustrating a fourth exemplary operation of a controller of a radio communicator according to a third exemplary embodiment.

### DESCRIPTION OF THE PREFERRED EMBODIMENTS

Referring now to the drawings in which like reference numerals designate identical or corresponding parts throughout the several views, various exemplary embodiments and operation of the present invention are next described.

### First Exemplary Embodiment

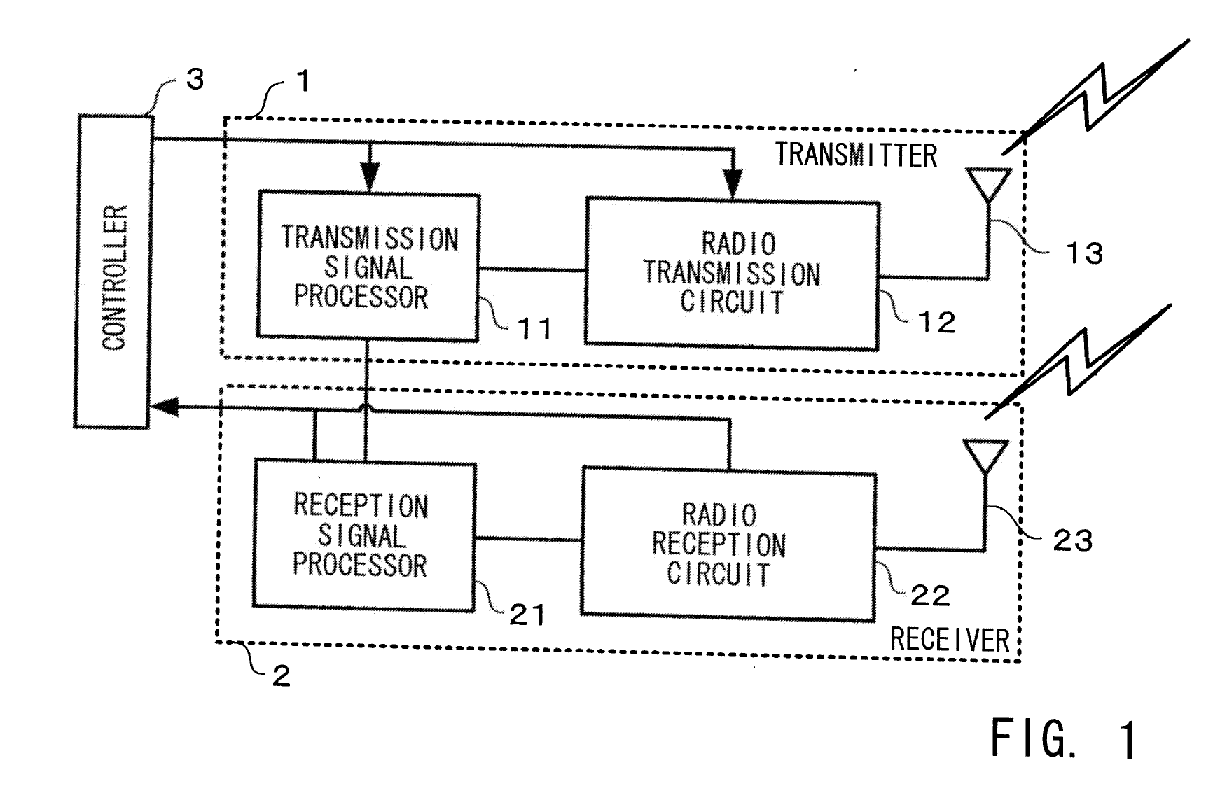

FIG. 1 illustrates a diagram of an example of a first exemplary embodiment of a radio communicator. In FIG. 1, the radio communicator includes a transmitter 1, receiver 2 and controller 3. The transmitter 1 includes a transmission signal processor 11, a radio transmission circuit 12, and a transmission antenna section 13. The receiver 2 monitors a radio wave condition in the air, and includes a reception signal processor 21, a radio reception circuit 22, and a reception antenna section 23. The controller 3 controls the transmitter 1 and the receiver 2.

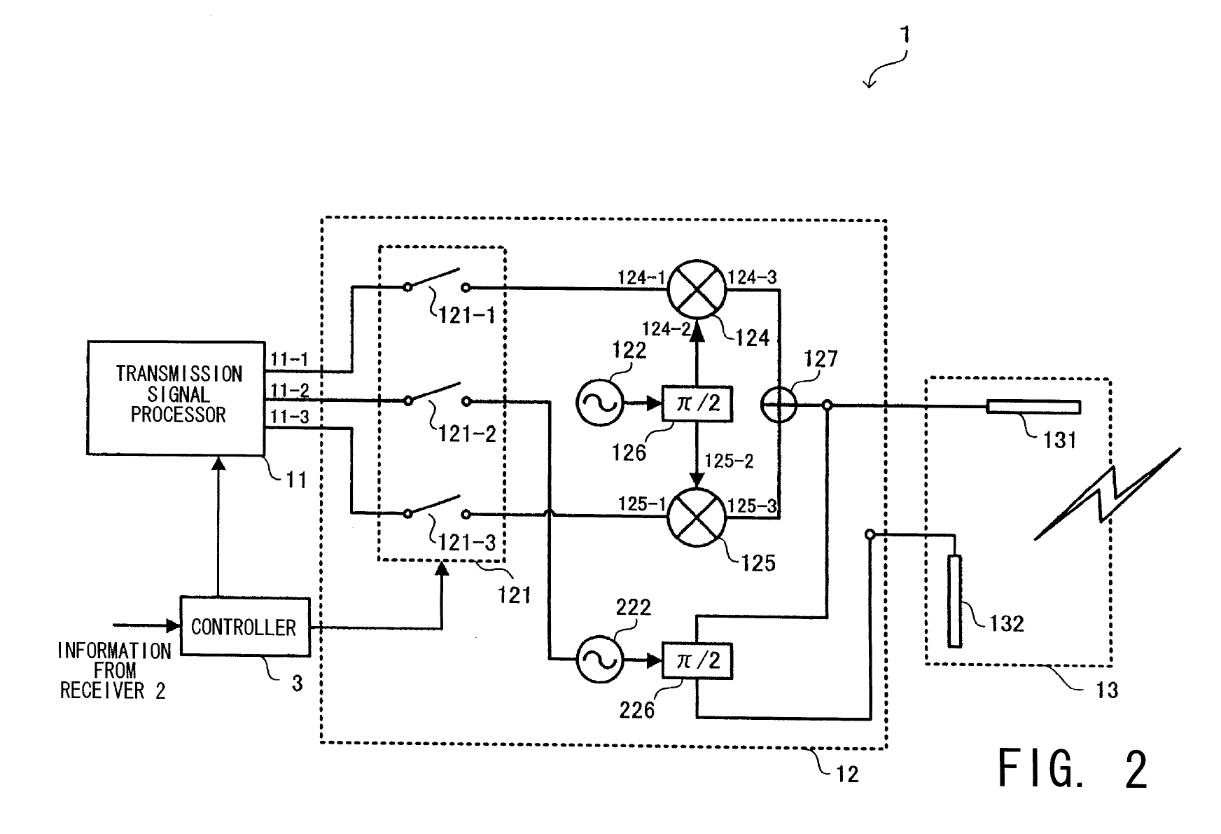

FIG. 2 illustrates further details of the radio communicator of FIG. 1. As shown in FIG. 2, the transmission signal processor 11 has three output terminals 11-1 to 11-3 connected to a switch set 121 included in the radio transmission circuit 12. The transmission signal processor 11 modulates transmission data to a baseband signal using either a QPSK modulation or a FSK modulation as a digital modulation.

Under control of the controller 3 which directs the modulation scheme, the baseband signal modulated using the FSK modulation is provided to the radio transmission circuit 12 from the output terminal 11-2. The baseband signal modulated using the QPSK modulation is provided to the radio transmission circuit 12 from the output terminals 11-1 and 11-3.

The radio transmission circuit 12 includes the switch set 121 including switches 121-1 to 121-3, a first local oscillator 122, a second local oscillator 222, a first mixer 124, a second mixer 125, a first phase shifter 126, a second phase shifter 226, and an adder 127.

The first local oscillator 122 generates a sine wave, and provides it to the first phase shifter 126.

The second local oscillator 222 is connected to the output terminal 11-2 of the transmission signal processor 11 through the switch 121-2. When the switch 121-2 shorts, the baseband signal is provided from the transmission signal processor 11 to the second local oscillator 222. Then, the second local oscillator 222 outputs a modulated sine wave to the second phase shifter 226.

The first mixer 124 has two input terminals 124-1 and 124-2, and an RF output terminal 124-3. The input terminal 124-1 connects to the output terminal 11-1 of the transmission signal processor 11 through the switch 121-1. The input terminal 124-2 connects to the first phase shifter 126. Signals input from input terminals 124-1 and 124-2 are converted to first RF signal by frequency mixing. The RF output terminal 124-3 provides the first RF signal to the adder 127.

The second mixer 125 has two input terminals 125-1 and 125-2, and RF output terminal 125-3. The input terminal 125-1 connects to the output terminal 11-3 of the transmission signal processor 11 through the switch 121-3. The input terminal 125-2 connects to the first phase shifter 126. Signals input from input terminals 125-1 and 125-2 are converted to a second RF signal by frequency mixing. The RF output terminal 125-3 provides the second RF signal to the adder 127.

The first phase shifter 126 generates a first shift signal and a second shift signal whose phase is orthogonal to that of the first shift signal. In this embodiment, the phase of the first shift signal shifts 0 degrees from the phase of the sine wave provided from the first local oscillator 122, and the phase of the second shift signal shifts 90 degrees from the phase of the sine wave provided from the first local oscillator 122. The first phase shifter 126 provides the first shift signal to the first mixer 124, and provides the second shift signal to the second mixer 125.

The adder 127 generates an addition signal that is an addition of the first RF signal provided form the first mixer 124 and the second RF signal provided from the second mixer 125. The adder 127 provides the addition signal to the first monopole antenna 131 of the transmission antenna section 13 and to the second phase shifter 226.

The first local oscillator 122, the first mixer 124, the second mixer 125, the first phase shifter 126, and the adder 127 configure a quadrature modulator.

The second phase shifter 226 generates a third shift signal, the phase of which shifts 0 degrees from phase of the modulated sine wave provided from the second local oscillator 222. The second phase shifter 226 also generates a fourth shift signal, the phase of which shifts 90 degrees from the phase of the modulated sine wave provided from the second local oscillator 222. The second phase shifter 226 further generates a fifth shift signal, the phase of which shifts 90 degrees from the phase of the addition signal provided from the adder 127. The second phase shifter 226 provides the third shift signal to the first monopole antenna 131, and provides the fourth shift signal to the second monopole antenna 132. Additionally, the second phase shifter 226 provides the fifth shift signal to the second monopole antenna 132.

The transmission antenna section 13 includes the first monopole antenna 131 and the second monopole antenna 132, as described above. The first monopole antenna 131 is connected to the adder 127. The second monopole antenna 132 is connected to the second phase shifter 226 and is physically perpendicular to the first monopole antenna 131.

The first monopole antenna 131 and the second monopole antenna may be another type antenna that can emit a linear polarized wave.

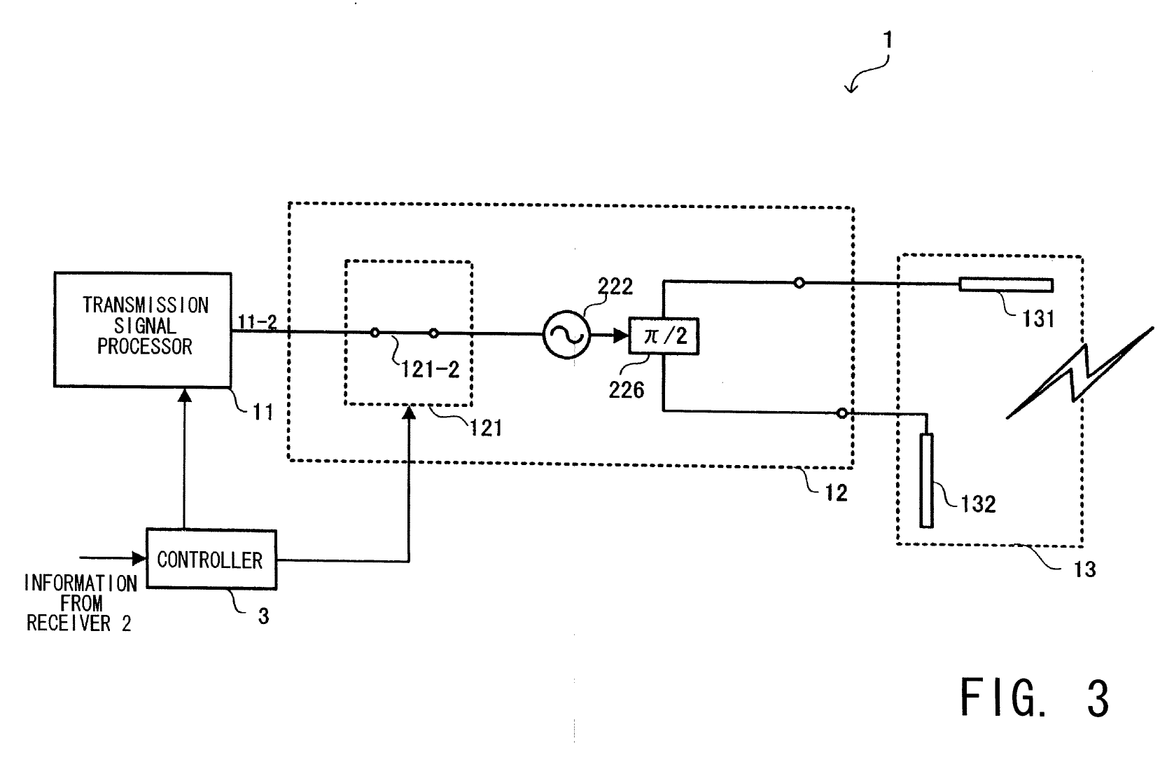

Operation of the radio communicator in this embodiment is described below referring to FIGS. 3 to 5.

The controller 3 judges the radio wave condition in the air based on a reception signal received by the receiver 2. The controller 3 classifies the radio signal condition in the air into three classes, including case 1 which indicates the radio signal condition in the air is bad, case 3 which indicates the radio signal condition in the air is good, and a case 2 which indicates the radio signal condition in the air is medium between the case 1 and the case 3.

When the controller 3 determines the actual radio signal condition to be case 1, the controller 3 directs the transmission signal processor 11 to modulate transmission data to the baseband signal using the FSK modulation which is robust over fluctuation of signal level and noise, and to send the FSK modulated signal using circular polarization which is robust over fading.

When the controller 3 determines the actual radio signal condition to be case 2, the controller 3 directs the transmission signal processor 11 to modulate transmission data to the baseband signal using the QPSK modulation which enables high transmission efficiency, and to send the QPSK modulated signal using the circular polarization.

When the controller 3 determines the actual radio signal condition to be case 3, the controller 3 directs the transmission signal processor 11 to modulate transmission data to the baseband signal using the QPSK modulation, and to send the QPSK modulated signal using linear polarization.

Details of each case are described below, respectively.

(Case 1)

FIG. 3 illustrates a partial diagram of the transmitter 1 of the radio communicator when the controller 3 determines actual radio signal condition to be case 1.

The controller 3 directs the transmission signal processor 11 to modulate transmission data to the baseband signal using FSK modulation, and to output the FSK modulating signal from the output terminal 11-2. The controller 3 lets the switch 121-2 short, and the controller 3 lets switches 121-1 and 121-3 open.

The second local oscillator 222 outputs a modulated sine wave to the second phase shifter 226. The frequency of the modulated sine signal depends on the FSK modulating signal obtained through the switch 121-2. The second local oscillator 222 provides the modulated sine wave to the second phase shifter 226.

The second phase shifter 226 generates a third shift signal, the phase of which is shifted 0 degrees from the phase of the modulated sine wave provided from the second local oscillator 222. The second phase shifter 226 also generates a fourth shift signal, the phase of which is shifted 90 degrees from phase of the modulated sine wave provided from the second local oscillator 222. The second phase shifter 226 provides the third shift signal to the first monopole antenna 131, and provides the fourth shift signal to the second monopole antenna 132.

The first monopole antenna 131 emits the third shift signal as a linear polarized wave. The second monopole antenna 132 emits the fourth shift as a linear polarized wave.

Since phase difference between the third shift signal and the fourth shift signal is 90 degrees, those signals emitted from the first monopole antenna 131 and the second monopole antenna 132 are combined into a circular polarized wave.

(Case 2)

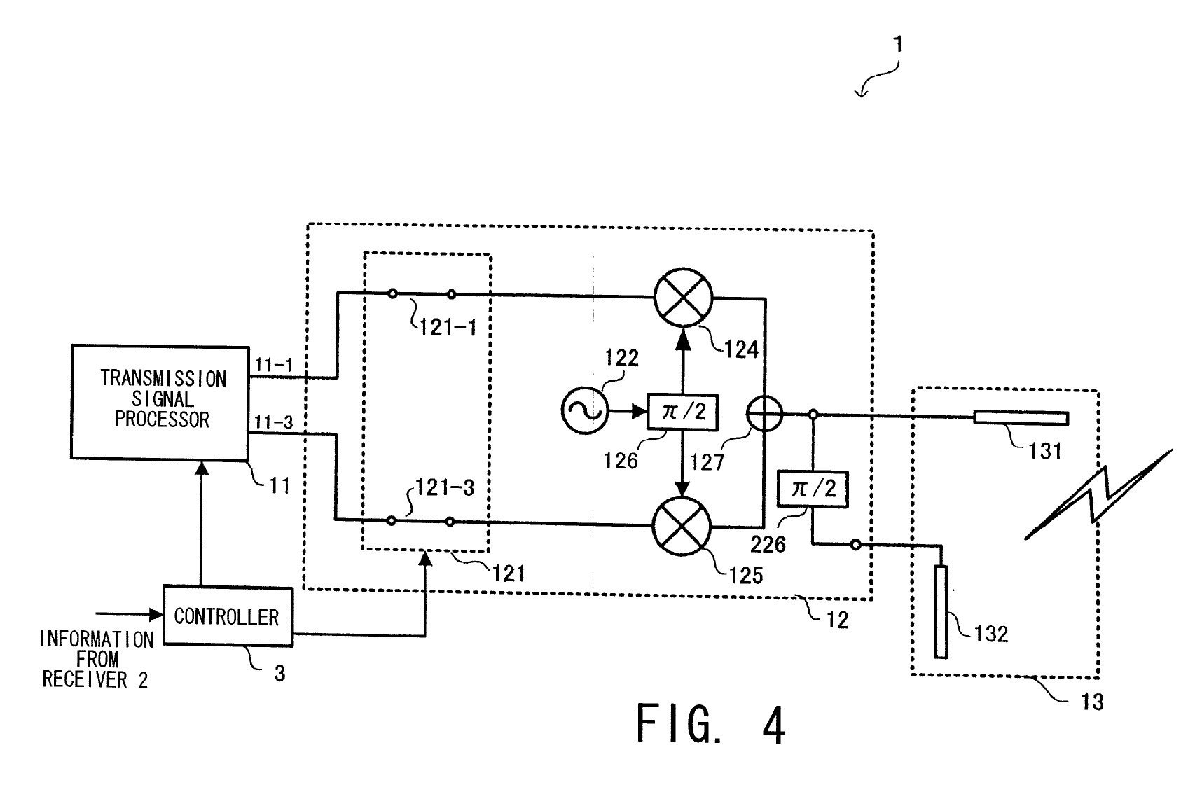

FIG. 4 illustrates a partial diagram of the transmitter 1 of the radio communicator when the controller 3 determines the actual radio signal condition to be case 2.

The controller 3 then directs the transmission signal processor 11 to modulate transmission data to the baseband signal using the QPSK modulation, and directs to output the QPSK modulated signal from the output terminals 11-1 and 11-3. The controller 3 lets switches 121-1 and 121-3 short, and the controller 3 lets the switch 121-2 open.

The second phase shifter 226 generates the fifth shift signal, the phase of which is shifted 90 degrees from phase of the addition signal provided from the adder 127. The second phase shifter 226 provides the fifth shift signal to the second monopole antenna 132.

The transmission signal processor 11 provides the I channel component of the QPSK modulated signal from the output terminal 11-1 to the first mixer 124 through the switch 121-1, and provides the Q channel component of the QPSK modulated signal from the output terminal 11-3 to the second mixer 125 through the switch 121-3.

The first mixer 124 converts the I channel component to the first RF signal using the first shift signal provided from the first phase shifter 126. The first mixer 124 provides the first RF signal from the RF output terminal 124-3 to the adder 127.

The second mixer 125 converts the Q channel component to the second RF signal using the second shift signal provided from the first phase shifter 126. The second mixer 125 provides the second RF signal from the RF output terminal 125-3 to the adder 127.

The adder 127 generates the addition signal that is an addition of the first RF signal and the second RF signal. The adder 127 provides the addition signal to the first monopole antenna 131 of the transmission antenna section 13, and to the second phase shifter 226.

The second phase shifter 226 generates the fifth shift signal, the phase of which is shifted 90 degrees from phase of the addition signal provided from the adder 127. The second phase shifter 226 provides the fifth shift signal to the second monopole antenna 132.

The first monopole antenna 131 emits the addition signal. The second monopole antenna 132 emits the fifth shift signal. Then, the addition signal and the fifth shift signal are linear polarized, respectively.

Since the phase difference between the addition signal and the fifth shift signal is 90 degrees, those signals emitted from the first monopole antenna 131 and the second monopole antenna 132 are combined into a circular polarized wave.

(Case 3)

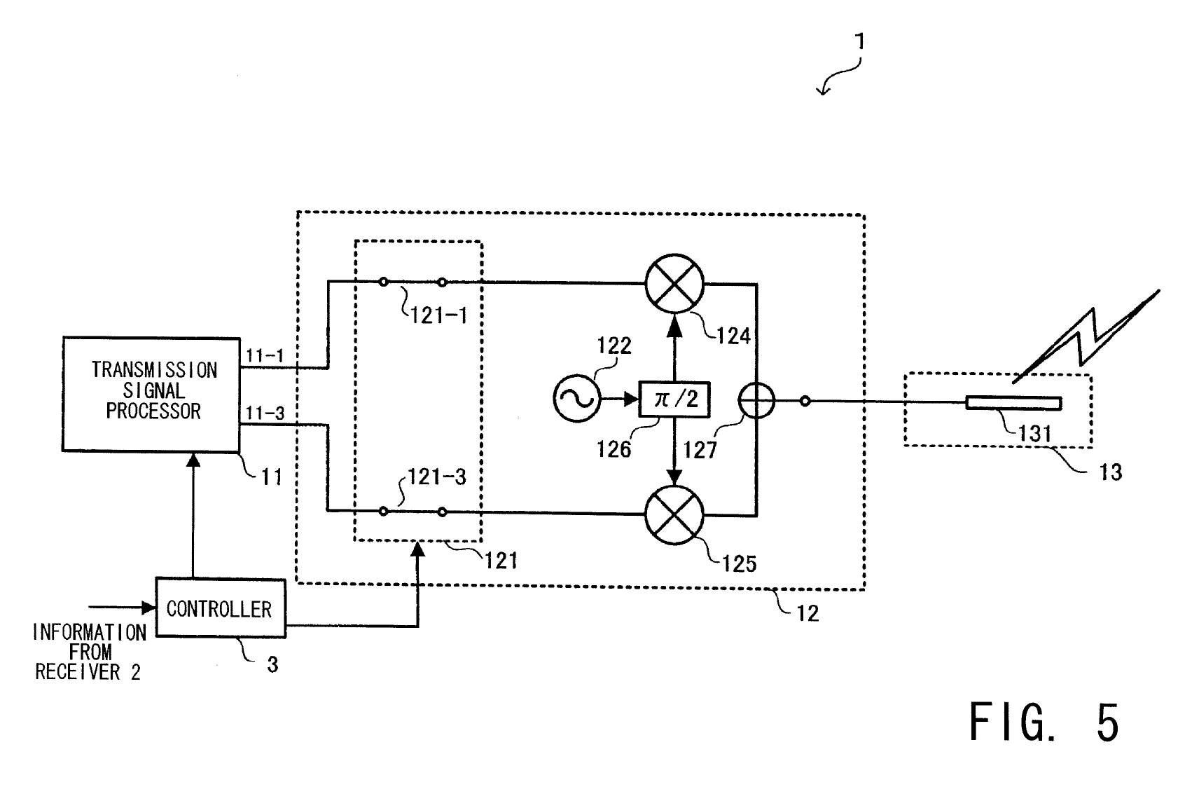

FIG. 5 illustrates a partial diagram of the transmitter 1 of the radio communicator when the controller 3 determines the actual radio signal condition to be case 3.

The controller 3 directs the transmission signal processor 11 to modulate transmission data to the baseband signal using the QPSK modulation, and directs to output the QPSK modulated signal from the output terminals 11-1 and 11-3. The controller 3 lets switches 121-1 and 121-3 short, and the controller 3 lets the switch 121-2 open.

The transmission signal processor 11 provides the I channel component of the QPSK modulated signal from the output terminal 11-1 to the first mixer 124 through the switch 121-1, and provides the Q channel component of the QPSK modulated signal from the output terminal 11-3 to the second mixer 125 through the switch 121-3.

The first mixer 124 converts the I channel component to the first RF signal using the first shift signal provided from the first phase shifter 126. The first mixer 124 provides the first RF signal to the adder 127 through the RF output terminal 124-3.

The second mixer 125 converts the Q channel component to the second RF signal using the second shift signal provided from the first phase shifter 126. The second mixer 125 provides the second RF signal to the adder 127 through from the RF output terminal 125-3.

The adder 127 generates the addition signal that is an addition of the first RF signal and the second RF signal. The adder 127 provides the addition signal to the first monopole antenna 131 of the transmission antenna section 13.

The first monopole antenna 131 emits the addition signal. Then, the addition signal is linear polarized.

As described above, when the actual radio signal condition is bad, data is converted to two sine wave signals orthogonal to each other. One of two sine wave signals is emitted from the first monopole antenna 131 as a linear polarized wave, and the other of two sine wave signals is emitted from the second monopole antenna 132 perpendicular to the first monopole antenna 131 as linear polarized wave. Those two linear polarized waves perpendicular to each other combine into a circular polarized wave.

Therefore this invention eliminates the need for a special circuit for converting polarization type.

Frequency shift keying in the broad sense of the term, including GMSK and GFSK, can be used as substitutes for the FSK. Phase shift keying in the broad sense of the term, including 8PSK and quadrature amplitude modulation schemes such as 16QAM, can be used as substitutes for the QPSK.

### Second Exemplary Embodiment

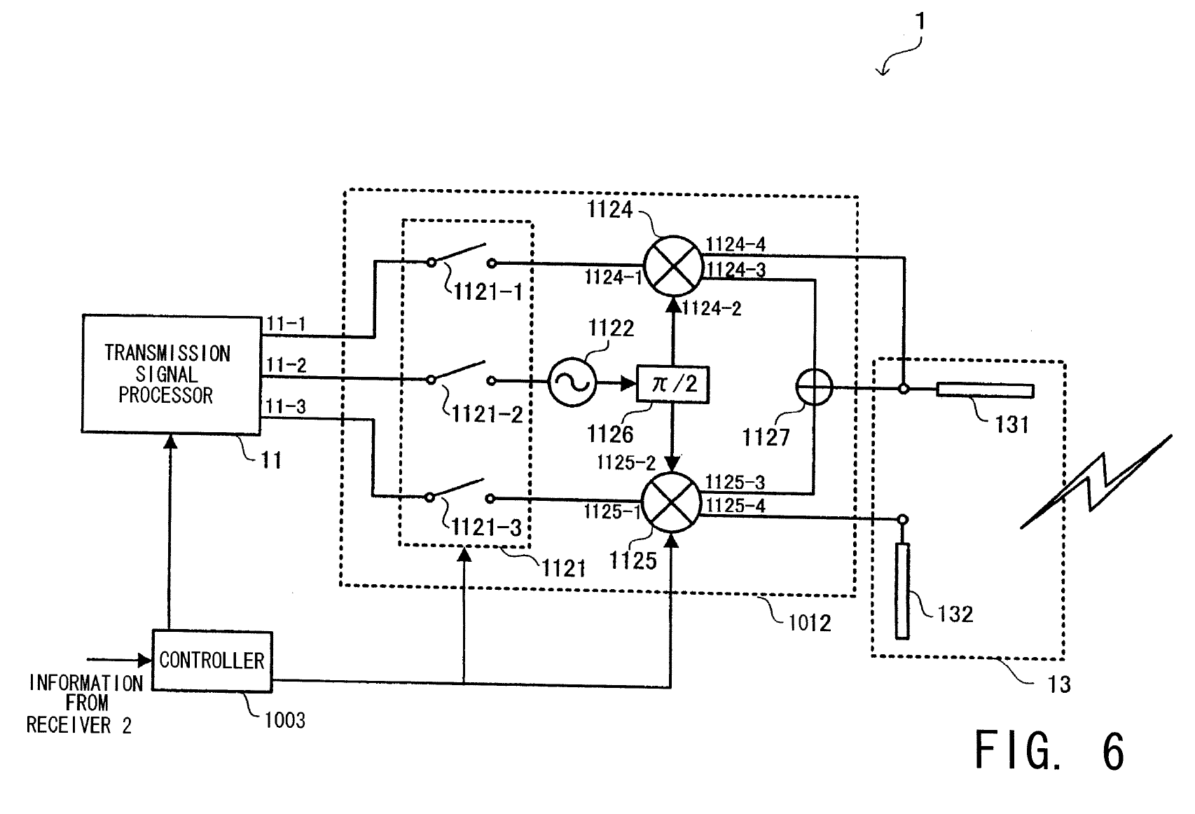

A second exemplary embodiment of a radio communicator is described below referring to FIGS. 6 to 8.

In this embodiment, a radio transmission circuit 1012 is different from radio transmission circuit 12 in the first exemplary embodiment.

FIG. 6 illustrates a block diagram of another example of the transmitter 1 including an example of a radio transmission circuit 1012 and a controller 1003.

The radio transmission circuit 1012 includes a switch set 1121 including switches 1121-1 to 1121-3, a first local oscillator 1122, a first mixer 1124, a second mixer 1125, a phase shifter 1126, and an adder 1127.

Compared to the radio transmission circuit 12 in the first exemplary embodiment, the radio transmission circuit 1012 does not include components corresponding to the second local oscillator 222 and second phase shifter 226. The first mixer 1124 has two input terminals 1124-1 and 1124-2, and two RF output terminals 1124-3 and 1124-4. The input terminal 1124-1 connects to the output terminal 11-1 of the transmission signal processor 11 through the switch 1121-1. The input terminal 1124-2 connects to the phase shifter 1126. Signals input from input terminals 1124-1 and 1124-2 are converted to a first RF signal by frequency mixing. The first mixer 1124 has two operation modes including mixer mode and local leak mode. In the mixer mode, the RF output terminal 1124-3 provides the first RF signal to the adder 1127 and the RF output terminal 1124-4 provides nothing, or the RF output terminal 1124-3 provides nothing and the RF output terminal 1124-4 provides the first RF signal to the first monopole antenna 131. In the local leak mode, the RF output terminals 1124-3 and 1124-4 output a first shift signal provided from the phase shifter 1126 without frequency change.

The second mixer 1125 has two input terminals 1125-1 and 1125-2, and two RF output terminals 1125-3 and 1125-4. The input terminal 1125-1 connects to the output terminal 11-3 of the transmission signal processor 11 through the switch 1121-3. The input terminal 1125-2 connects to the phase shifter 1126. Signals input from input terminals 1125-1 and 1125-2 are converted to a second RF signal by frequency mixing. The second mixer 1125 also has two operation modes including mixer mode and local leak mode. In the mixer mode, the RF output terminal 1125-3 provides the second RF signal to the adder 1127 and the RF output terminal 1125-4 provides nothing, or the RF output terminal 1125-3 provides nothing and the RF output terminal 1125-4 provides the second RF signal to the second monopole antenna 132. In the local leak mode, the RF output terminals 1125-3 and 1125-4 output a second shift signal provided from the phase shifter 1126 without frequency change.

The local oscillator 1122 is connected to the output terminal 11-2 of the transmission signal processor 11 through the switch 1121-2. The local oscillator 1122 generates a sine wave, and provides the sine wave to the phase shifter 1126.

When the switch 1121-2 shorts, the baseband signal is provided from the transmission signal processor 11 to the local oscillator 1122. Then, the local oscillator 1122 outputs a modulated sine wave to the phase shifter 1126.

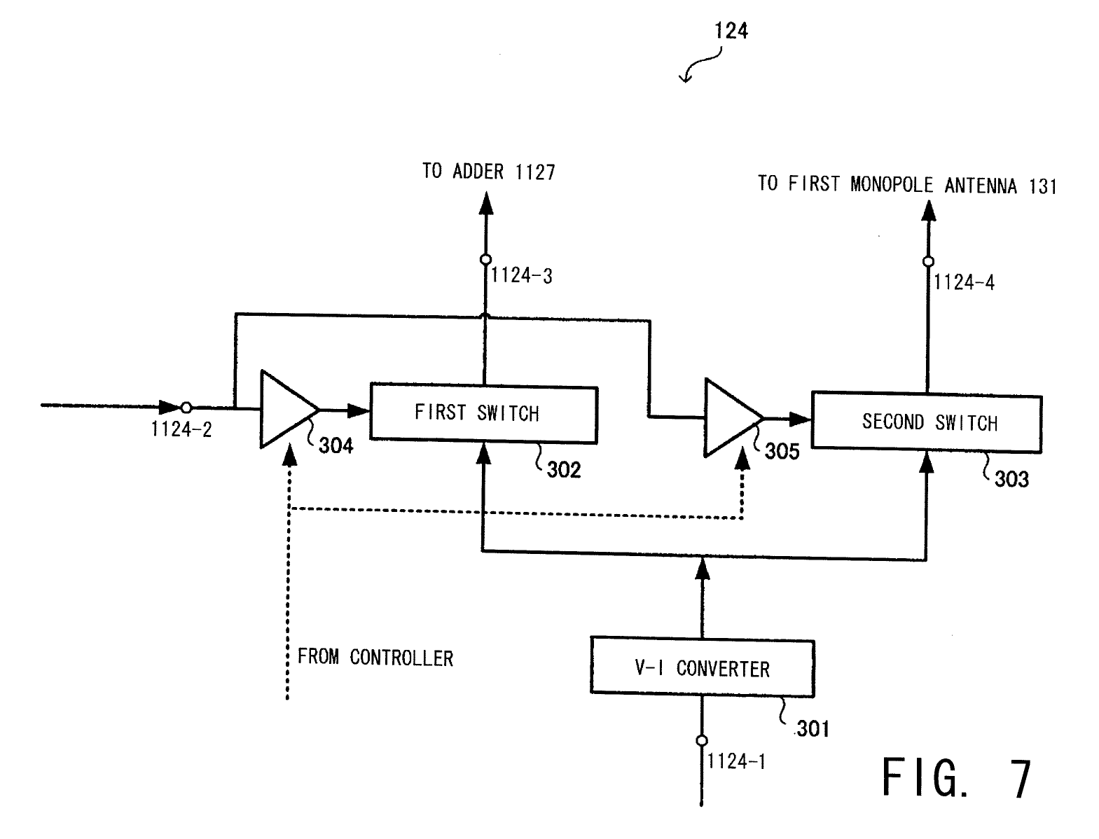

FIG. 7 illustrates a functional block diagram of an example of the first mixer 1124. The second mixer 1125 may be similar configuration.

The first mixer 1124 includes a V-I converter 301, a first switch 302, a second switch 303, a first local buffer amplifier 304, and a second local buffer amplifier 305.

The V-I converter 301 receives modulated signal provided from the output terminal 11-1 of the transmission signal processor 11 through the switch 1121-1. The V-I converter 301 converts the modulated signal, which is a kind of voltage signal, into a current signal. The V-I converter 301 provides the current signal to the first switch 302 and the second switch 303.

The local buffer amplifier 304 amplifies the first shift signal provided from the phase shifter 1126 to generate a first amplified local signal. The local buffer amplifier 305 amplifies the first shift signal provided from the phase shifter 1126 to generate a second amplified local signal.

The first switch 302 mixes frequencies of the current signal and the first amplified local signal to generate a first mixed signal. The second switch 303 mixes frequencies of the current signal and the second amplified local signal to generate a second mixed signal.

The controller 1003 controls the local buffer amplifier 304, the local buffer amplifier 305, and the digital signal processor 11.

In the mixer mode, the controller 1003 enables only one of two switches. The controller 1003 enables the first local buffer amplifier 304 to output the first amplified local signal, and disables the second local buffer amplifier 305 to output the second amplified local signal. Then, the first amplified local signal is provided to the first switch 302, but the second amplified local signal is not provided to the second switch 303. That is, the controller 1003 enables only the first switch 302 between two switches. Or, the controller 1003 enables the second local buffer amplifier 305 to output the second amplified local signal, and disables the first local buffer amplifier 304 to output the first amplified local signal. Then, the second amplified local signal is provided to the second switch 303, but the first amplified local signal is not provided to the first switch 302. That is, the controller 1003 enables only the second switch 303 between two switches. In the local leak mode, the controller 1003 directs the digital signal processor 11 to output stationary signal from the output terminal 11-1. The stationary signal is provided to the V-I converter 301 through the switch 1121-1. Then, since frequency of the current signal become zero, the first switch 302 outputs the first amplified local signal as the first mixed signal, and the second switch 303 outputs the second amplified local signal as the second mixed signal.

An operation of the transmitter 1 in this embodiment is described below.

First, the controller 1003 judges the radio signal condition in the air based on a reception signal received by the receiver 2.

When the controller 1003 determines the actual radio signal condition to be case 1 which indicates bad condition, the controller 1003 directs the transmission signal processor 11 to modulate transmission data to the baseband signal using the FSK modulation and to send the FSK modulated signal using circular polarization.

When the controller 3 determines the actual radio signal condition to be case 3 which indicates good condition, the controller 3 directs the transmission signal processor 11 to modulate transmission data to the baseband signal using the QPSK modulation, and to send the QPSK modulated signal using linear polarization.

(Case 1)

The operation of the transmitter 1 when the controller 1003 determines the actual radio signal condition to be case 1 is described below using FIG. 6.

The controller 1003 directs the transmission signal processor 11 to modulate transmission data to the baseband signal using the FSK modulation, and directs to output the FSK modulated signal from the output terminal 11-2. The controller 1003 directs the transmission signal processor 11 to output the stationary signal from output terminals 11-1 and 11-3, also.

The controller 1003 lets switches 1121-1 to 1121-3 short, lets the first mixer 1124 output the first RF signal from the RF output terminal 1124-4, and lets the second mixer 1125 output the second RF signal from the RF output terminal 1125-4.

The FSK modulated signal is provided to the local oscillator 1122 through the switch 1121-2. The local oscillator 1122 outputs modulated sine wave to the first phase shifter 1126.

The phase shifter 1126 generates the first shift signal, the phase of which shifts 0 degrees from phase of the modulated sine wave provided from the local oscillator 1122. The phase shifter 1126 generates the second shift signal also, the phase of which shifts 90 degrees from phase of the modulated sine wave provided from the local oscillator 1122. The phase shifter 1126 provides the first shift signal to the first mixer 1124, and provides the second shift signal to the second mixer 1125.

The first mixer 1124 receives the stationary signal from the output terminal 11-1 of the digital signal processor 11 through the switch 1121-1, and then the first mixer 1124 operates under the local leak mode. The second mixer 1125 receives the stationary signal from the output terminal 11-3 of the digital signal processor 11 through the switch 1121-3, and then the second mixer 1125 operates under the local leak mode. That is, the first mixer 1124 provides the first shift signal to the first monopole antenna 131 without change, and the second mixer 1125 provides the second shift signal to the second monopole antenna 132 without change.

The first monopole antenna 131 and the second monopole antenna 132 emit the first shift signal and the second shift signal as linear polarized waves, respectively.

Since phase difference between these sine waves is 90 degrees, those signals emitted from the first monopole antenna 131 and the second monopole antenna 132 are combined into a circular polarized wave.

(Case 3)

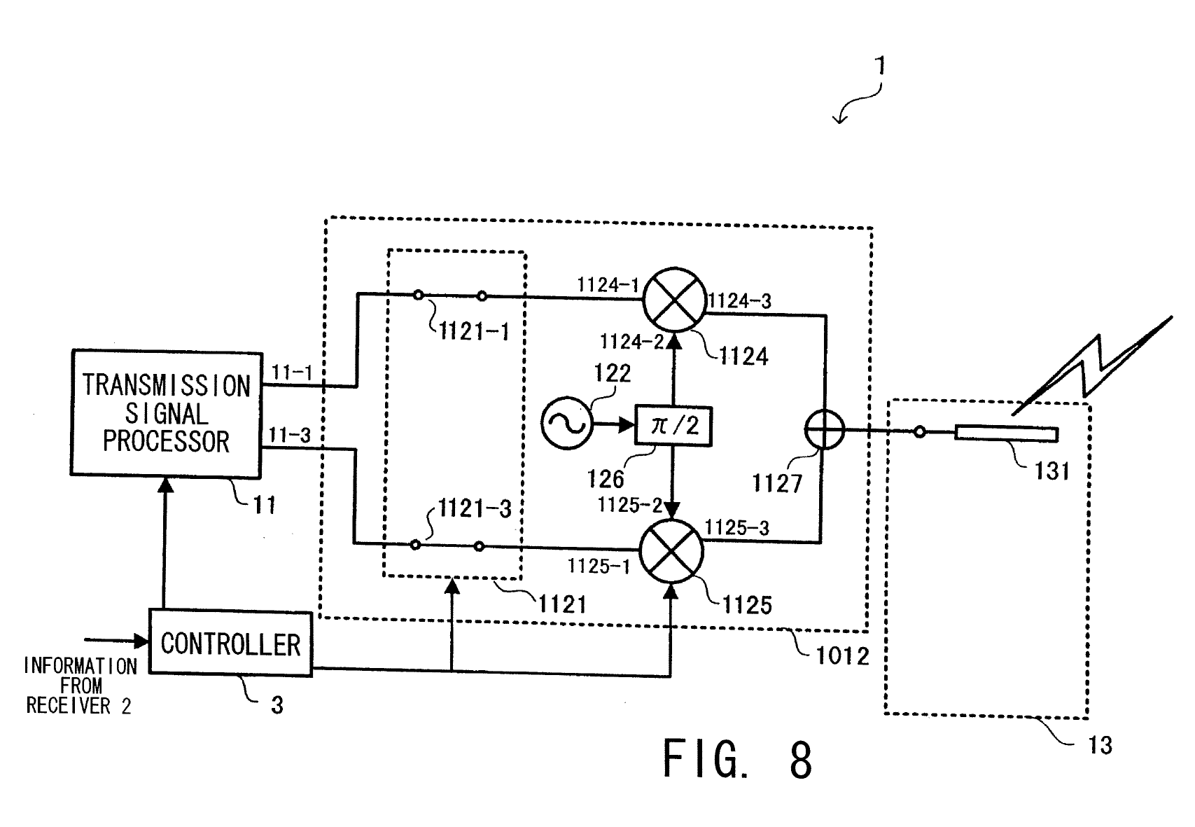

FIG. 8 illustrates a functional block diagram of the transmitter 1 of the radio communicator when the controller 1003 determines the actual radio signal condition to be case 3.

The controller 1003 directs the transmission signal processor 11 to modulate transmission data to the baseband signal using the QPSK modulation, and directs to output an I channel component of the QPSK modulated signal from the output terminal 11-1 and a Q channel component of the QPSK modulated signal from the output terminal 11-3.

The controller 1003 lets switches 1121-1 to 1121-3 short, lets the switch 1121-2 open, lets the first mixer 1124 output the first RF signal from the RF output terminal 1124-3, and lets the second mixer 1125 output the second RF signal from the RF output terminal 1125-3.

The I channel component and the Q channel component are provided to the first mixer 1124 and the second mixer 1125, respectively.

The first mixer 1124 also receives the first shift signal and converts the I channel component and the first shift signal to the first RF signal by frequency mixing. The RF output terminal 1124-3 provides the first RF signal to the adder 1127.

The second mixer 1125 also receives the second shift signal and converts the Q channel component and the second shift signal to the second RF signal by frequency mixing. The RF output terminal 1125-3 provides the second RF signal to the adder 1127.

The adder 1127 generates an addition signal from addition of the first RF signal provided from the first mixer 1124 and the second RF signal provided from the second mixer 1125, and provides the addition signal to the first monopole antenna 131.

The first monopole antenna 131 emits the addition signal as a linear polarized wave.

As described above, the local leak mode of the first mixer 1124 and the second mixer 1125 enables to omit components corresponding to the second local oscillator 222 and second phase shifter 226 from the radio transmission circuit 1012.

### Third Exemplary Embodiment

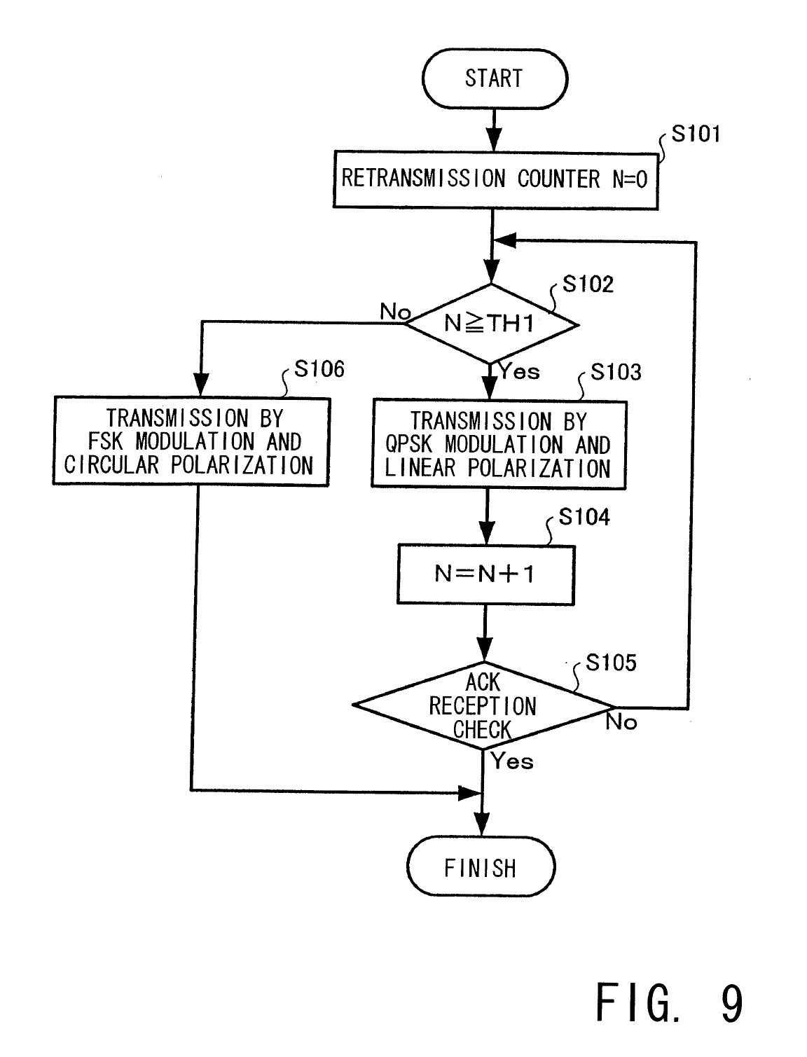

A third exemplary embodiment of a radio communicator is described below by reference to FIGS. 9 to 12.

The physical configuration of the radio communicator in the third embodiment may be the same as in the first or the second exemplary embodiment. The physical configuration of the first exemplary embodiment is employed to explain the characteristic operation of a controller in this embodiment.

The radio communicator in this embodiment transmits a data packet as the transmission data to a radio receiver. The radio receiver can send back some response such as an ACK packet, which is sent as an acknowledgement of normal reception of the data packet, to the radio communicator.

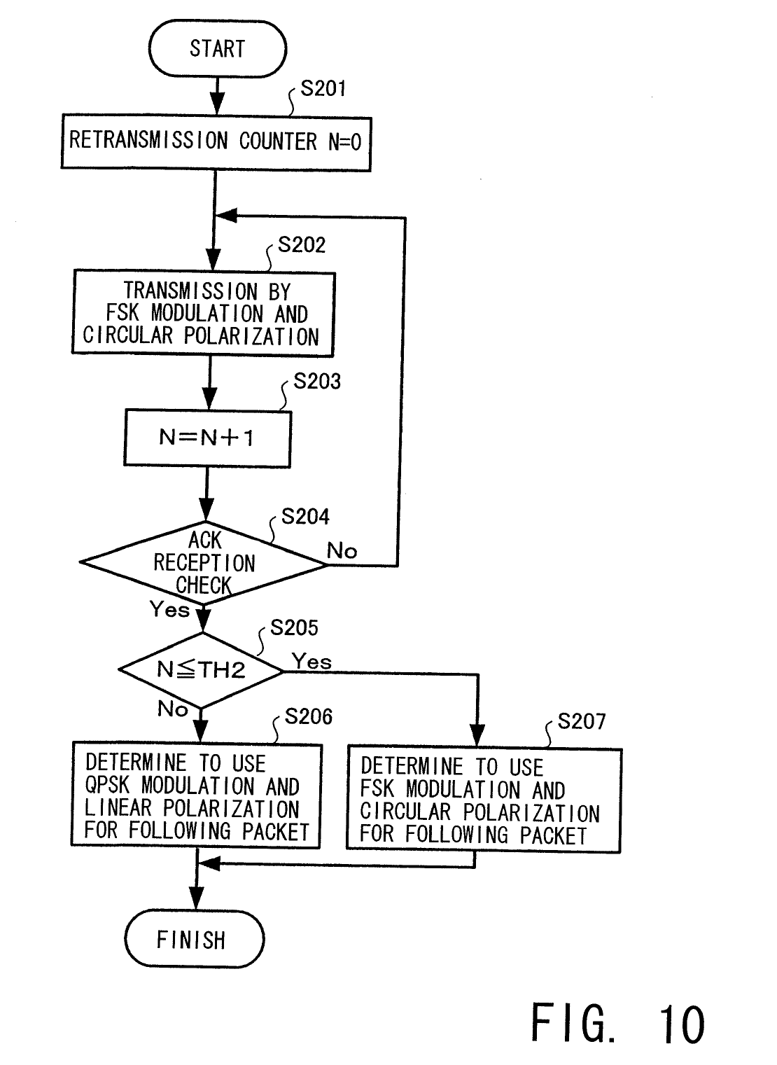

FIGS. 9 and 10 illustrate flowcharts of the operation of the controller 3 with judgment of radio signal condition in the air based on a retransmission counter.

The controller 3 has a memory to store a modulation scheme and polarization type. The memory stores which modulation scheme and polarization type are finally chosen at transmission of the previous packet.

FIG. 9 illustrates an operation of the controller 3 if the modulation scheme and polarization type finally employed at transmission of the previous packet are the QPSK modulation and the linear polarization.

At the first transmission of the data packet, the controller 3 initializes a retransmission counter N as 0 (step S101).

The controller 3 compares the counter N with a predetermined threshold number TH1 (step S102).

The threshold TH1 is greater than zero. Therefore, the counter N is smaller than the threshold TH1 at the first time of transmission to operate the step S102.

If the counter N is smaller than the threshold TH1 (“Yes” of the step S102), the controller 3 judges the radio signal condition in the air as still good, and the controller 3 directs the transmission signal processor 11 to modulate the data packet to the baseband signal using the QPSK modulation and to send the QPSK modulated signal using linear polarization (step S103), to increase the counter N by 1 (step S104), and to wait the ACK packet from the radio receiver.

The controller 3 checks whether the receiver 2 has received the ACK packet (step S105).

If the controller 3 determines the receiver 2 has received the ACK packet (“Yes” of the step S105), the controller 3 directs the transmission signal processor 11 to terminate the transmission of the data packet.

If the controller 3 determines the receiver 2 has not received the ACK packet (“No” of the step S105), the controller 3 directs the transmission signal processor 11 to retry the step S102.

If the counter N equal or is greater than the threshold TH1 (“No” of the step S102), the controller 3 judges the radio signal condition in the air as bad, and the controller 3 directs the transmission signal processor 11 to modulate the data packet to the baseband signal using the FSK modulation and to send the FSK modulated signal using circular polarization (step S106), and to terminate the transmission of the data packet.

FIG. 10 illustrates an operation of the controller 3 if the modulation scheme and polarization type finally employed at transmission of the previous packet are the FSK modulation and the circular polarization such as the step S106 in the FIG. 9.

At first transmission of the data packet, the controller 3 initializes a retransmission counter N as zero (step S201).

The controller 3 directs the transmission signal processor 11 to modulate the data packet to the baseband signal using the FSK modulation and to send the FSK modulated signal using circular polarization (step S202), the increase the counter N by 1 (step S203), and to wait the ACK packet from the radio receiver.

The controller 3 checks whether the receiver 2 has received the ACK packet (step S204).

If the controller 3 determines the receiver 2 has not received the ACK packet (“No” of the step S204), the controller 3 directs the transmission signal processor 11 to retry the step S202.

If the controller 3 determines the receiver 2 has received the ACK packet (“Yes” of the step S204), the controller 3 compares the counter N with a predetermined threshold number TH2 (step S205).

If the counter N equals the threshold TH2 or less (“No” of the step S205), the controller 3 judges the radio signal condition in the air as improved, and the controller 3 determines the modulation scheme and the polarization type for a data packet following the data packet transmitted in the step S202 as the QPSK modulation and linear polarization (step S206).

If the counter N is greater than the threshold TH2 (“Yes” of the step S205), the controller 3 judges the radio signal condition in the air as still bad, and the controller 3 determines the modulation scheme and the polarization type for a data packet following the data packet transmitted in the step S202 as the FSK modulation and circular polarization (step S207).

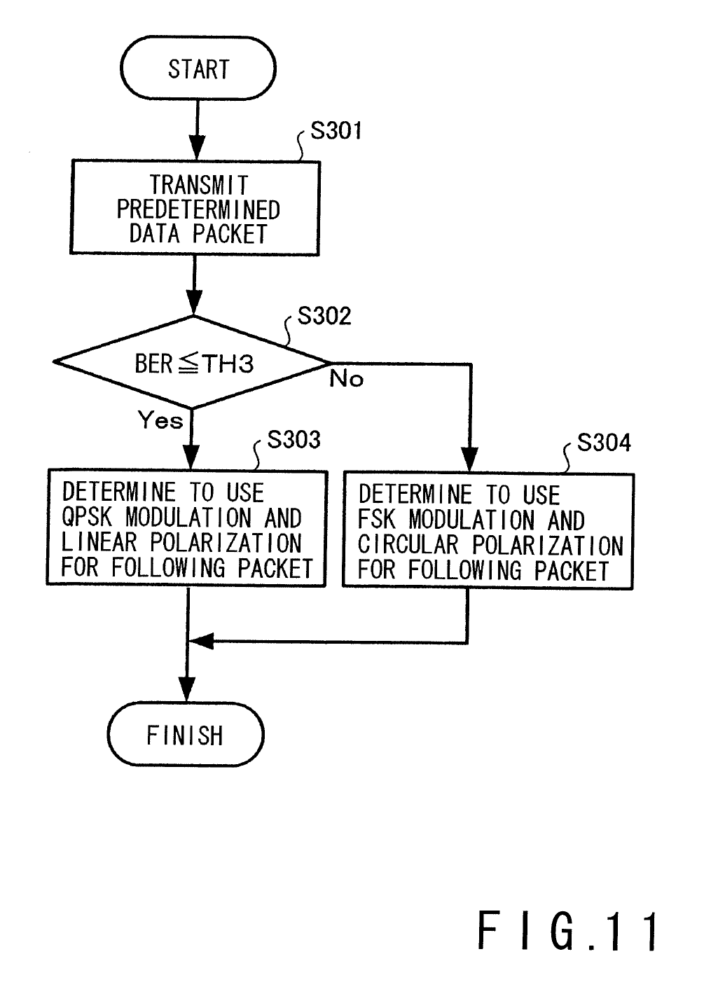

FIG. 11 illustrates a flowchart of the operation of the controller 3 using judgment of radio signal condition in the air based on a BER (bit error rate).

At first, the radio communicator transmits a predetermined data packet. The controller 3 directs the transmission signal processor 11 to modulate the predetermined data packet to the baseband signal using the same modulation scheme as the previous packet transmission, and to send the modulated signal using the same polarization type as the previous packet transmission (step S301). The radio receiver sends back a BER calculated by comparing a received packet with a predetermined data pattern stored in the radio receiver.

On receiving the BER from the radio receiver, the controller 3 compares the BER with a predetermined threshold value TH3 (step S302).

If the BER equals the threshold TH3 or less (“Yes” of the step S302), the controller 3 judges the radio signal condition in the air as good, and the controller 3 determines the modulation scheme and the polarization type for a data packet following the predetermined data packet as the QPSK modulation and linear polarization (step S303).

If the BER is greater than the threshold TH3 (“No” of the step S302), the controller 3 judges the radio signal condition in the air as bad, and the controller 3 determines the modulation scheme and the polarization type for a data packet following the predetermined data packet as the FSK modulation and circular polarization (step S304).

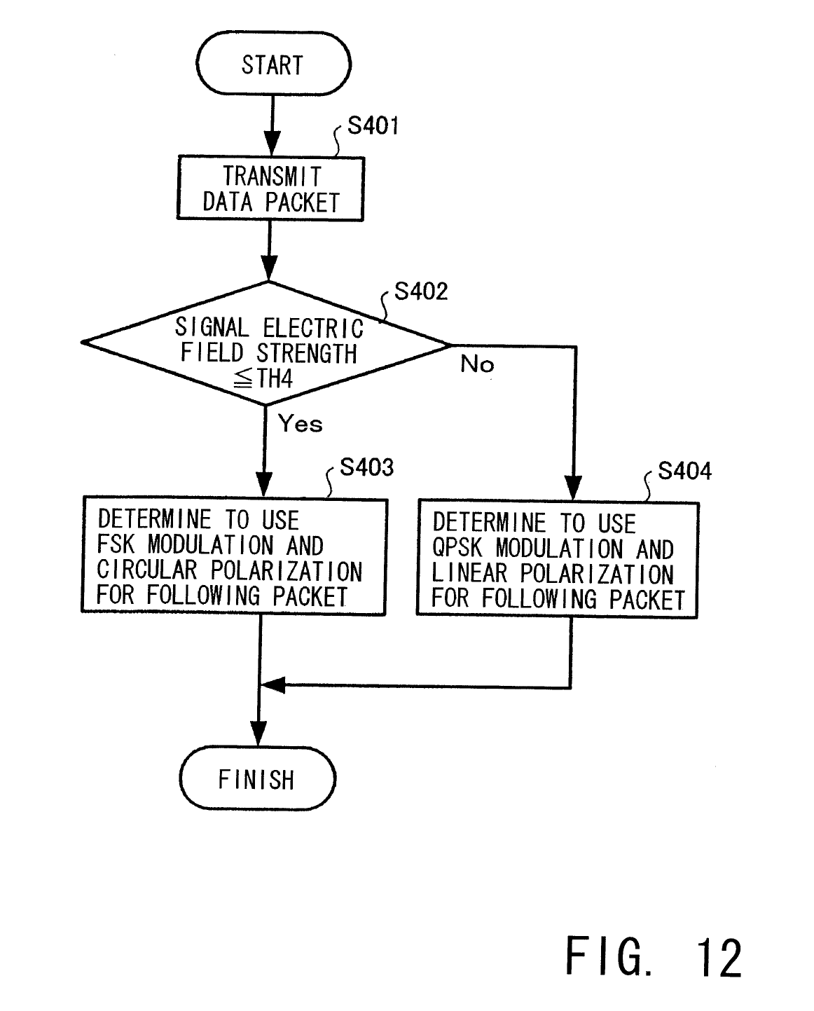

FIG. 12 illustrates a flowchart of the operation of the controller 3 with judgment of radio signal condition in the air based on signal electric field strength.

At first transmission of the data packet, the controller 3 directs the transmission signal processor 11 to modulate the data packet to the baseband signal using the same modulation scheme as the previous packet transmission, and to send the modulated signal using the same polarization type as the previous packet transmission (step S401). The radio receiver sends back signal electric field strength measured with a received packet.

On receiving the signal electric field strength from the radio receiver, the controller 3 compares the signal electric field strength with a predetermined threshold value TH4 (step S402).

If the signal electric field strength equals the threshold TH4 or less (“Yes” of the step S402), the controller 3 judges the radio signal condition in the air as bad, and the controller 3 determines the modulation scheme and the polarization type for the following the data packet as the FSK modulation and circular polarization (step S403).

If the signal electric field strength is bigger than the threshold TH4 (“No” of the step S402), the controller 3 judges the radio signal condition in the air as good, and the controller 3 determines the modulation scheme and the polarization type for the following data packet as the QPSK modulation and linear polarization (step S404).

If the radio receiver also judges a radio signal condition in the air for transmission of the radio receiver itself, according to reciprocity theorem, the radio receiver can use the signal electric field strength measured by the radio receiver itself for the judgment.

In above explanation, the controller 3 judges the radio signal condition in the air into two levels such as good or bad, but three or more level judgment can be realized by employing two or more threshold numbers.

Numerous modifications and variations of the present invention are possible in light of the above teachings. It is therefore to be understood that within the scope of the appended claims, the invention may be practiced otherwise than as specifically described herein.

1. A radio communicator comprising:
a first antenna configured to emit radio signal as a first linear polarized wave;
a second antenna arranged perpendicular to the first antenna and configured to emit radio signal as a second linear polarized wave;
a receiver configured to monitor radio wave condition in the air;
a transmitter configured to convert transmission data to a first radio signal and a second radio signal with a phase orthogonal to the phase of the first radio signal, and to transmit the first radio signal and the second radio signal through the first antenna and the second antenna; and
a controller configured to make judgment of the radio wave condition monitored by the receiver, to direct the transmitter to transmit the first radio signal through the first antenna and to transmit the second radio signal through the second antenna when the result of the judgment is a first condition, and to direct the transmitter to transmit an addition signal which is an addition of the first radio signal and the second radio signal through the first antenna when the result of the judgment is a second condition.

2. The radio communicator of claim 1, wherein:
the first condition is worse than the second condition.

3. The radio communicator of claim 1, wherein:
the transmitter is configured to modulate the transmission data to the first radio signal with frequency shift keying, and to modulate the transmission data to the first radio signal and the second radio signal with phase shift keying; and
the controller is configured to direct the transmitter to modulate the transmission data to the first radio signal with the frequency shift keying when the result of the judgment is the first condition, and to direct the transmitter to modulate the transmission data to the first radio signal and the second radio signal with the phase shift keying when the result of the judgment is the second condition.

4. The radio communicator of claim 3, wherein:
the transmitter includes a frequency modulator configured to modulate the transmission data with the frequency shift keying, and a quadrature modulator configured to modulate the transmission data with the phase shift keying; and
the controller is configured to direct the transmitter to modulate the transmission data to the first radio signal with the frequency modulator when the result of the judgment is the first condition, and to direct the transmitter to modulate the transmission data with the quadrature modulator when the result of the judgment is the second condition.

5. The radio communicator of claim 1, wherein:
the first antenna and the first antenna comprise respective monopole antennas.

6. The radio communicator of claim 1, wherein:
the transmitter includes,
a digital modulator configured to modulate the transmission data to a first modulated signal with the frequency shift keying, and to modulate the transmission data to a second modulated signal, which includes an in-phase component and a quadrature component, with the phase shift keying,
a first oscillator configured to generate as the first radio signal a first sine wave-with a frequency controlled by the first modulated signal,
a second oscillator configured to generate a second sine wave,
a first phase shifter configured to generate a first shift signal and a second shift signal from the second sine wave, with the phase of the first shift signal orthogonal to that of the second shift signal,
a first mixer configured to mix the in-phase component of the second modulated signal and the first shift signal to first RF signal,
a second mixer configured to mix the quadrature component of the second modulated signal and the second shift signal to the second RF signal,
an adder configured to generate the addition signal that is an addition of the first RF signal and the second RF signal, as the first radio signal, and
a second phase shifter configured to generate a third shift signal having a phase orthogonal to that of the first radio signal, as the second radio signal; and
the controller is configured to direct the digital modulator to modulate the transmission data to the first modulated signal when the result of the judgment is the first condition, and to direct the digital modulator to modulate the transmission data to the first modulated signal when the result of the judgment is the second condition.

7. The radio communicator of claim 1, wherein:
the transmitter includes,
a digital modulator configured to modulate the transmission data to a first modulated signal with the frequency shift keying, to modulate the transmission data to a second modulated signal, which includes in-phase component and quadrature component, with the phase shift keying, and to output a first stationary signal and a second stationary signal,
an oscillator configured to generate a sine wave with a frequency controlled by the first modulated signal and the first stationary signal,
a first phase shifter configured to generate a first shift signal and a second shift signal from the second sine wave, with the phase of the first shift signal orthogonal to that of the second shift signal,
a first mixer configured to generate a first RF signal by mixing the in-phase component of the second modulated signal and the first shift signal, and to generate the first radio signal by mixing the second stationary signal and the first shift signal,
a second mixer configured to generate a second RF signal by mixing the quadrature component of the second modulated signal and the second shift signal, and to generate the second radio signal by mixing the second stationary signal and the second shift signal, and
an adder configured to generate the addition signal that is an addition of the first RF signal and the second RF signal, as the first radio signal; and
the controller is configured to direct the digital modulator to modulate the transmission data to the first modulated signal and to output the second stationary signal when the result of the judgment is first condition, and to direct the digital modulator to modulate the transmission data to the second modulated signal and to output the first stationary signal when the result of the judgment is the second condition.

8. The radio communicator of claim 1, wherein:
the controller is configured to make judgment of the radio wave condition monitored by the receiver, based on a count of a retransmission counter.

9. The radio communicator of claim 1, wherein:
the controller is configured to make judgment of the radio wave condition monitored by the receiver, based on a bit error rate.

10. The radio communicator of claim 1, wherein:
the controller is configured to make judgment of the radio wave condition monitored by the receiver, based on signal electric field strength.
